(19) United States
(12) Patent Application Publication
(10) Pub. No.: US 2026/0283074 A1
(43) Pub. Date: Sep. 24, 2026

(54) APPARATUS TO CONTROL A DRUM AND SPINDLES OF A COTTON HARVESTER ROW UNIT

(71) Applicant: Deere & Company, Moline, IL (US)

(72) Inventors: Kevin Jacob Goering, Cambridge, IA (US); Joel M. Schreiner, Saddlebrooke, MO (US)

(21) Appl. No.: 19/451,783

(22) Filed: Jan. 16, 2026

Related U.S. Application Data
(60) Provisional application No. 63/775,136, filed on Mar. 20, 2025.

(51) Int. Cl. A01D 46/18; A01D 46/08

(52) U.S. Cl. CPC A01D 46/18; A01D 46/085

(57) ABSTRACT

An apparatus to control a drum and spindles of a cotton harvester row unit is described. An example apparatus includes a shaft operatively coupled to a first motor, the shaft defining a rotational axis, the first motor to drive rotation of the shaft about the rotational axis at a first rotational speed; a spindle drive gear coupled to and extending circumferentially around the shaft, the spindle drive gear to rotate with the shaft about the rotational axis at the first rotational speed to control rotation of the spindles, and a drum drive gear operatively coupled to the shaft via a planetary gear system, the drum drive gear and the planetary gear system extending circumferentially around the shaft, a second motor and the shaft to drive rotation of the drum drive gear about the rotational axis at a second rotational speed to control rotation of the drum.

### RELATED APPLICATION

This patent claims the benefit of U.S. Provisional Patent Application No. 63/775,136, which was filed on Mar. 20, 2025. U.S. Provisional Patent Application No. 63/775,136 is hereby incorporated herein by reference in its entirety. Priority to U.S. Provisional Patent Application No. 63/775,136 is hereby claimed.

### FIELD OF THE DISCLOSURE

This disclosure relates generally to agricultural vehicles and, more particularly, to an apparatus to control a drum and spindles of a cotton harvester row unit.

### BACKGROUND

Cotton harvesters are agricultural vehicles that may be used to harvest cotton from a field. Some cotton harvesters include row units including rotating drums and spindles to gather cotton material from planted rows as the cotton harvester travels forward in the field. The row units then convey the gathered cotton material to an internal compartment of the cotton harvester, where the cotton material can be stored and/or formed into modules. Rotational speeds of the drums and spindles may be selected and/or adjusted based on a forward travel speed of the cotton harvester.

### SUMMARY

A first example apparatus to control a drum and spindles of a row unit of a cotton harvester includes a shaft operatively coupled to a first motor, the shaft defining a rotational axis, the first motor to drive rotation of the shaft about the rotational axis at a first rotational speed, a spindle drive gear coupled to and extending circumferentially around the shaft, the spindle drive gear to rotate with the shaft about the rotational axis at the first rotational speed, the rotation of the spindle drive gear to control rotation of the spindles, and a drum drive gear operatively coupled to the shaft via a planetary gear system, the drum drive gear and the planetary gear system extending circumferentially around the shaft, a second motor and the shaft to drive, via the planetary gear system, rotation of the drum drive gear about the rotational axis at a second rotational speed, the second rotational speed based on the first rotational speed, the rotation of the drum drive gear to control rotation of the drum.

A second example apparatus includes the first example apparatus, wherein the planetary gear system includes a sun gear coupled to and extending circumferentially around the shaft, the sun gear to rotate with the shaft about the rotational axis at the first rotational speed, a ring gear extending circumferentially around the sun gear, the second motor to drive rotation of the ring gear about the rotational axis at a third rotational speed, a planet gear operatively coupled between the sun gear and the ring gear, and a carrier operatively coupled between the planet gear and the drum drive gear, the carrier to rotate about the rotational axis at the second rotational speed, the second rotational speed based on a ratio between the first rotational speed and the third rotational speed.

A third example apparatus includes the second example apparatus, further including a first sensor and a second sensor coupled to a housing of the row unit, the first sensor configured to detect the first rotational speed of the shaft, the second sensor configured to detect the third rotational speed of the ring gear.

A fourth example apparatus includes the second example apparatus, wherein the sun gear includes 22 teeth, the planet gear includes 20 teeth, and the ring gear includes 62 teeth.

A fifth example apparatus includes the second example apparatus, further including an input ring gear fixedly coupled to and rotatable with the ring gear, the ring gear including internal teeth positioned on an inner circumference of the ring gear, the input ring gear including external teeth positioned on an outer circumference of the input ring gear.

A sixth example apparatus includes the fifth example apparatus, wherein the external teeth are first external teeth, the first external teeth to engage second external teeth of an output gear coupled to an output shaft of the second motor.

A seventh example apparatus includes the first example apparatus, wherein the first motor is rotatable in two directions, and the second motor is rotatable in one direction.

An eighth example apparatus includes the first example apparatus, further including a positive displacement pump operatively coupled to the shaft, rotation of the shaft to drive operation of the positive displacement pump, the operation of the positive displacement pump to drive circulation of oil in a housing of the row unit.

A ninth example apparatus includes the first example apparatus, wherein at least one of the first motor or the second motor includes a hydraulic motor.

A tenth example apparatus includes the first example apparatus, wherein the shaft is a first shaft including a first bevel gear, further including a second shaft operatively coupled to and substantially perpendicular to the first shaft, the second shaft including a second bevel gear to engage the first bevel gear, the first motor to drive rotation of the second shaft, the second shaft to drive rotation of the first shaft via the first and second bevel gears.

An eleventh example apparatus includes the tenth example apparatus, wherein the row unit is a first row unit, the spindles are first spindles, the second shaft to extend to a second row unit of the cotton harvester, rotation of the second shaft to drive rotation of the first spindles of the first row unit and second spindles of the second row unit at substantially the same speed.

A twelfth example apparatus includes a first drive gear to be operatively coupled to spindles of a row unit of a cotton harvester, a second drive gear to be operatively coupled to a drum of the row unit, and a drive shaft to be fixedly coupled to the first drive gear and to be operatively coupled, via a planetary gear system, to the second drive gear, the first and second drive gears and the planetary gear system to extend circumferentially around the drive shaft, the first drive gear to rotate with the drive shaft about a longitudinal axis of the drive shaft, the second drive gear rotatable relative to the first drive gear about the longitudinal axis.

A thirteenth example apparatus includes the twelfth example apparatus, wherein the planetary gear system includes a sun gear fixedly coupled to and rotatable with the drive shaft, a ring gear spaced about from and extending circumferentially around the drive shaft, a planet gear coupled between the sun gear and the ring gear, the planet gear to travel around the drive shaft based on relative rotation between the sun gear and the ring gear, and a carrier coupled between the second drive gear and the planet gear.

A fourteenth example apparatus includes the thirteenth example apparatus, wherein the sun gear, the ring gear, and the planet gear are oriented along substantially the same plane.

A fifteenth example apparatus includes the thirteenth example apparatus, further including a first motor operatively coupled to the drive shaft to drive rotation of the drive shaft, the first drive gear, and the sun gear about the longitudinal axis at a first rotational speed, and a second motor operatively coupled to the ring gear to drive rotation of the ring gear about the longitudinal axis at a second rotational speed, the second drive gear to rotate about the longitudinal axis at a third rotational speed based on the first rotational speed and the second rotational speed.

A sixteenth example apparatus includes the fifteenth example apparatus, wherein at least one of the first motor or the second motor includes a hydraulic motor.

A seventeenth example apparatus includes the fifteenth example apparatus, wherein the first motor is rotatable in a first direction and a second direction, the second motor rotatable in one of the first direction or the second direction.

An eighteenth example apparatus includes the fifteenth example apparatus, wherein the first motor is operatively coupled to the drive shaft via an input shaft, the input shaft substantially perpendicular to the drive shaft.

A nineteenth example apparatus includes the eighteenth example apparatus, wherein the row unit is a first row unit, the spindles are first spindles, the input shaft to extend to a second row unit of the cotton harvester, rotation of the input shaft to drive rotation of the first spindles of the first row unit and second spindles of the second row unit at substantially the same speed.

A twentieth example apparatus includes the twelfth apparatus, further including a pump operatively coupled to the drive shaft, rotation of the drive shaft to drive operation of the pump to drive circulation of lubricant in a housing of the row unit.

### BRIEF DESCRIPTION OF THE DRAWINGS

FIG. 1A is a side view of an example cotton harvester in which examples described herein may be implemented.

FIG. 1B is a perspective view of the cotton harvester of FIG. 1A.

FIG. 2 is a partial perspective view of an example row unit of the cotton harvester of FIGS. 1A and 1B.

FIG. 3 is a perspective view of an example gearbox constructed in accordance with teachings of this disclosure.

FIG. 4 is a cross-sectional view of the gearbox of FIG. 3.

FIG. 5 is a top-down view of an example planetary gear system of the gearbox of FIGS. 3 and 4.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Some agricultural vehicles, commonly referred to as cotton harvesters or cotton pickers, may be used to harvest cotton from a field. Cotton harvesters typically include a set of row units (e.g., cotton harvester row units) coupled to a front end of the cotton harvesters. As the cotton harvester travels forward along one or more rows of cotton plants in the field, the row units can operate to gather the cotton plants (or a portion thereof) into the cotton harvester for processing. Typically, a row unit includes spindles operatively coupled to respective drums. During operation of the cotton harvester, the drums rotate about respective first longitudinal axes (e.g., drum axes) of the drums, and the spindles rotate with the drums about the longitudinal axes. Further, the spindles can rotate about respective second longitudinal axes (e.g., spindle axes) extending radially outward from the respective drums, where the spindles are elongated along the respective second longitudinal axes.

When the spindles rotate with the respective drums about the drum axes and further rotate about the respective spindle axes, the rotating spindles separate seed cotton from the cotton plants and draw the seed cotton into elongate fibers. The row unit can further include a doffer that rotates in a counteracting manner relative to the spindles, such that rotation of the doffer removes harvested cotton material from the spindles. The cotton material is then transferred (e.g., using a vacuum tube and/or other conveying mechanism) to a module-forming area of the cotton harvester. Once a module of the cotton material is formed, the module can be ejected from the cotton harvester onto the field, and may be collected at a later time.

In many cotton harvesters, rotation speeds of the drums and spindles are mechanically linked, such that a change in the rotation speed of the drums results in a corresponding change in the rotation speed of the spindles. Further, the drum speeds (and, thus, the resulting spindle speeds) are typically directly proportional to a ground speed (e.g., a forward travel speed) of the cotton harvester. As a result, the spindle speeds may be reduced and/or limited based on the ground speed and/or the drum speeds, and such limitation of the spindle speeds may negatively impact picking efficiency and/or conveying capacity of the cotton harvester, particularly in varying and/or high yielding cotton conditions.

In recent years, some cotton harvesters have been developed to enable independent control of the drum speed (e.g., drum rotational speed) and spindle speed (e.g., spindle rotational speed) of a corresponding row unit. For instance, the drum and spindle speeds can be controlled independently to adapt to variations in crop and/or field conditions. As a result, independent control of the drum and spindle speeds can improve efficiency of a cotton harvesting operation by increasing mass flow rate of cotton material into the cotton harvester, reducing cotton loss (e.g., reducing an amount of unharvested cotton remaining in the field), etc.

Examples described herein enable independent control of the drum speed and spindle speed of a row unit (e.g., a cotton harvester row unit) of a cotton harvester. For example, an example gearbox (e.g., a dual output gearbox) described herein includes a first drive gear (e.g., a spindle drive gear) operatively coupled to spindles of the row unit, and a second drive gear (e.g., a drum drive gear) operatively coupled to a drum of the row unit. Rotation of the spindle drive gear controls rotation of the spindles, and rotation of the drum drive gear controls rotation of the drum. The gearbox further includes a shaft (e.g., a driveshaft, a main input shaft) driven by a first motor (e.g., a hydraulic motor and/or an electric motor) to rotate about a rotational axis (e.g., a longitudinal axis of the shaft) at a first rotational speed. The spindle drive gear is coupled to and extends circumferentially around the shaft to rotate with the shaft about the rotational axis.

Further, in some examples, the drum drive gear is operatively coupled to the shaft via a planetary gear system extending circumferentially around the shaft. A second motor (e.g., a second hydraulic motor and/or a second electric motor) drives a ring gear of the planetary gear system at a second rotational speed, and a sun gear of the planetary gear system is driven by the shaft at the first rotational speed. The drum drive gear is operatively coupled to the sun and ring gears such that the drum drive gear rotates at a third rotational speed about the rotational axis, where the third rotational speed is based on a difference (e.g., a ratio) between the first rotational speed of the sun gear and the second rotational speed of the ring gear. As a result, the spindle drive gear and the drum drive gear and, thus, the spindles and the drum can be controlled to rotate at different (e.g., independent) rotational speeds.

By enabling variation of the spindle speed relative to the drum speed, examples described herein can improve efficiency of a cotton harvesting operation by increasing spindle speed (e.g., relative to ground speed) to increase mass flow rate of cotton material into the cotton harvester, reduce cotton loss, etc. Further, examples described herein utilize a single driveshaft to drive rotation of multiple gears (e.g., the spindle drive gear, the sun drive gear and, thus, the drum drive gear) about the driveshaft. As a result, examples described herein may utilize less power and/or may transmit power more efficiently compared to when power from the driveshaft is transferred to gearbox components spaced apart from the driveshaft (e.g., in a belt and pulley system). Additionally, by transmitting power via one or more gears (e.g., the planetary gear system), examples described herein can transmit power more reliably compared to when other type(s) of power transmission systems (e.g., belt and pulley systems) are used.

In examples described herein, the drum speed is based on relative rotation between a sun gear (e.g., controllable via a first motor) and a ring gear (e.g., controllable via a second motor) of the planetary gear system. In some examples, the relative rotation can be adjusted by driving the sun gear in two rotational directions (e.g., clockwise and counterclockwise about the driveshaft) while driving the ring gear in one direction (e.g., clockwise or counterclockwise about the driveshaft). Stated differently, the drum can be driven at a range of operational speeds by adjusting the first rotational speed of the sun gear in either of the two rotational directions but adjusting the second rotational speed of the ring gear in only one of the rotational directions. As a result of the ring gear being driven in only one direction, examples described herein can reduce complexity of a hydraulic system operatively coupled to the second motor. Further, use of the planetary gear system enables examples described herein to slow and/or reverse rotation of the drum without driving the second motor in a direction opposite to the first motor (e.g., without the second motor counteracting the first motor). As a result, the examples described reduce and/or prevent power inefficiencies associated with driving the second motor in reverse (e.g., relative to the first motor).

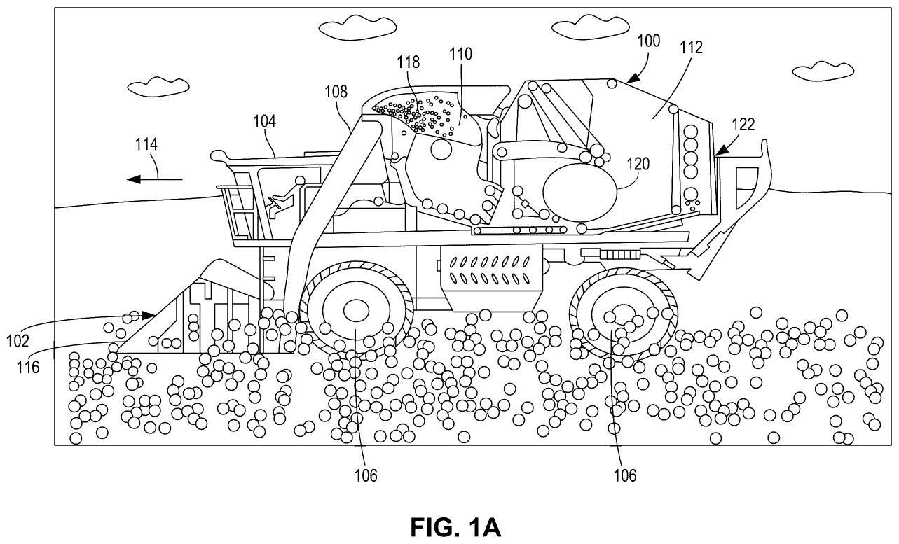

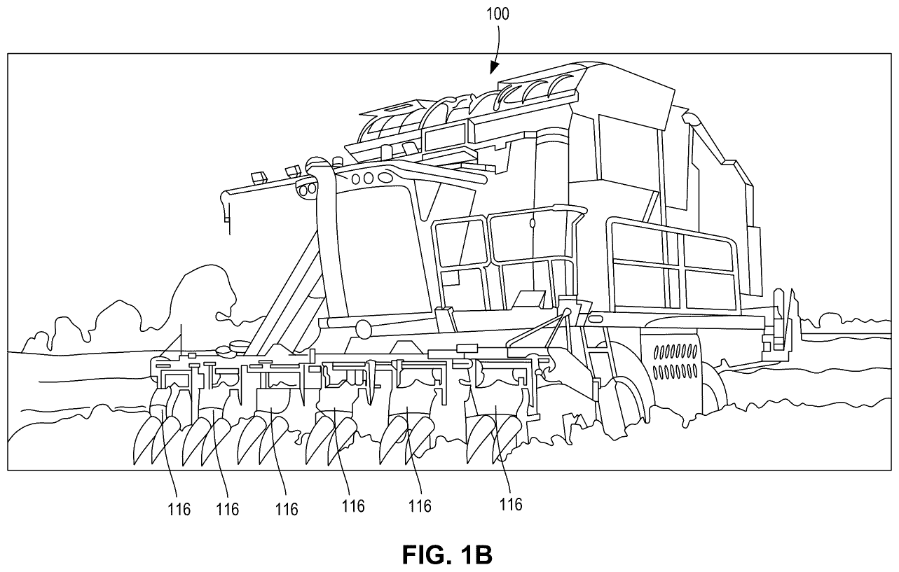

FIG. 1A is a side view of an example cotton harvester 100 in which examples described herein may be implemented. In the illustrated example of FIG. 1A, the cotton harvester 100 includes a front end 102, a cabin (e.g., an operator cabin) 104, wheels 106, a conveyor mechanism 108, a cotton containment area 110, and a module forming area 112. An engine (or other power source) drives movement of cotton harvester 100 in a forward direction (e.g., indicated by arrow 114). The cotton harvester 100 further includes row units 116 at the front end 102 of the cotton harvester 100. During operation, as the cotton harvester 100 moves in the forward direction 114 along rows of cotton plants in a field, the row units 116 can funnel cotton plants into the front end 102 and separate cotton material (e.g., seed cotton) 118 from the cotton plants. The conveyer mechanism 108 can convey (e.g., via vacuum pressure, positive air pressure, etc.) the cotton material 118 to the cotton containment area 110 and to the module forming area 112. In the module forming area 112, the cotton material can be formed into a module (e.g., a cotton module) 120. In some examples, when a size of the module 120 reaches a threshold size, the module 120 can be ejected (e.g., via a rearward portion 122 of the cotton harvester 100) from the module forming area 112 onto the field.

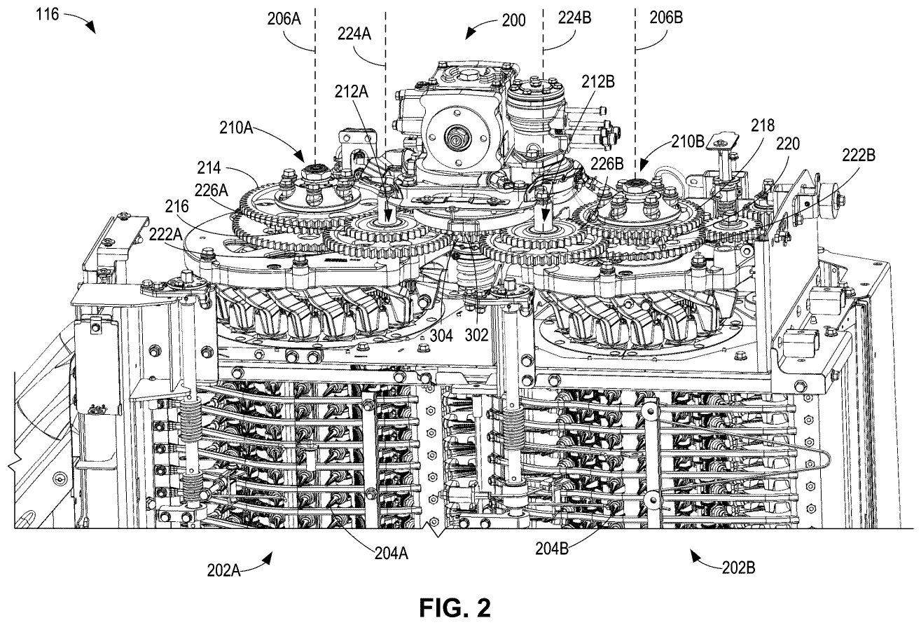

FIG. 1B is a perspective view of the cotton harvester 100 of FIG. 1A. In the illustrated example of FIG. 1B, the cotton harvester 100 includes six of the row units 116. In some examples, the cotton harvester 100 can include a different number of the row units 116 (e.g., four, five, seven or more, etc.). The row units 116 include spindles rotatably coupled to respective drums (e.g., rotating drums), as described further below in connection with FIG. 2. The spindles can rotate with the drums about first longitudinal axes of the drums, and can further rotate about second longitudinal axes of the spindles (e.g., where the second longitudinal axes of the spindles extend radially from the respective drums). During operation of the cotton harvester 100, spindles on respective pairs of the drums rotate relative to one another to draw cotton plants into the row units 116. Further, rotation of the spindles along the second longitudinal axes of the spindles removes cotton material from the cotton plants and/or draws the cotton material into elongate fibers for further processing by the cotton harvester 100. In some examples, rotation speeds of the drums and the spindles are controllable via motors (e.g., hydraulic motor(s) and/or electric motor(s)) operatively coupled to the drums and the spindles via gearboxes of the respective row units 116.

FIG. 2 is a partial perspective view of one of the row units 116 of the cotton harvester 100 of FIGS. 1A and 1B, with some portions removed or made transparent. In the illustrated example of FIG. 2, the row unit 116 includes an example gearbox (e.g., a dual-output gearbox) 200 constructed in accordance with teachings of this disclosure. The gearbox 200 can be used to control and/or adjust rotational speeds of a front drum 202A, a rear drum 202B, front spindles 204A operatively coupled to the front drum 202A, and/or rear spindles 204B operatively coupled to the rear drum 202B (e.g., where the front drum 202A and the rear drum 202B are collectively referred to herein as drums 202, and the front spindles 204A and the rear spindles 204B are collectively referred to herein as spindles 204). In this example, the front drum 202A and the rear drum 202B are rotatable about a front drum axis 206A and a rear drum axis 206B, respectively. Further, the spindles 206 are rotatable about respective spindle axes extending longitudinally along the respective spindles 206 (e.g., extending radially from the respective drums 202).

In the illustrated example of FIG. 2, a first drive gear stack 210A is operatively coupled to the front drum 202A and the front spindles 204A, and a second drive gear stack 210B is operatively coupled to the rear drum 202B and the rear spindles 204B. Further, the gearbox 200 is operatively coupled to the first drive gear stack 210A via a first idler gear stack 212A, and the gearbox 200 is operatively coupled to the second drive gear stack 210B via a second idler gear stack 212B. In this example, the first drive gear stack 210A includes a front drum drive gear 214 and a front spindle drive gear 216. The front drum drive gear 214 is operatively coupled to the front drum 202A to control rotation of the front drum 202A about the front drum axis 206A, and the front spindle drive gear 216 is operatively coupled (e.g., via a spool) to the front spindles 204A to control rotation of the front spindles 204A about the respective spindle axes. Similarly, the second drive gear stack 210B includes a rear drum drive gear 218 operatively coupled to the rear drum 202B to control rotation of the rear drum 202B about the rear drum axis 206B, and a rear spindle drive gear 220 operatively coupled (e.g., via a spool) to the rear spindles 204B to control rotation of the rear spindles 204B about the respective spindle axes.

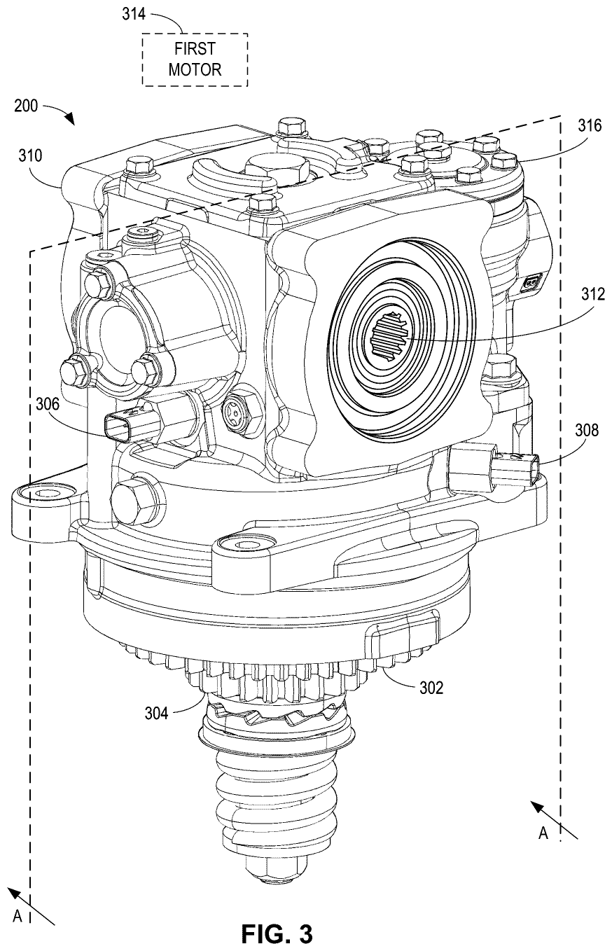

Turning to FIG. 3, a perspective view of the gearbox 200 of FIG. 2 is shown. In some examples, the gearbox 200 can be implemented in one or more of the row units 116 of FIGS. 1A and 1B to adjust and/or otherwise control rotational speeds of the associated drums (e.g., the drums 202 of FIG. 2) and the spindles (e.g., the spindles 204 of FIG. 2) independently. In the illustrated example of FIG. 3, the gearbox 200 includes an example drum drive gear 302 and an example spindle drive gear 304. Further, a first sensor (e.g., a first speed sensor) 306 and a second sensor (e.g., a second speed sensor) 308 are coupled to a housing 310 of the gearbox 200. In some examples, the first and second sensors 306, 308 can measure rotational speeds of one or more components of the gearbox 200, and the measured rotational speeds can be used to control and/or adjust one or more inputs to the gearbox 200. For example, the housing 310 includes an opening 312 to receive a driveshaft (not shown), where the driveshaft provides a first input to control a rotational speed of the drum drive gear 302 and the spindle drive gear 304. Further, motors (e.g., a first motor 314 and a second motor 316) can be operatively coupled to the gearbox 200 to provide a second input to control and/or adjust the rotational speed of the drum drive gear 302. In this example, the motors 314, 316 are hydraulic motors. In some examples, the motor(s) 314, 316 can include any suitable type of motor (e.g., electric motor(s), etc.).

Returning to FIG. 2, the gearbox 200 controls, based on input(s) from the first and second motors 314, 316 of FIG. 3, rotation of the drum drive gear 302 and the spindle drive gear 304 to control rotation of the drums 202 and the spindles 204, respectively. In the illustrated example of FIG. 2, the spindle drive gear 304 is operatively coupled to the front spindle drive gear 216 via a first front idler gear 222A, and is operatively coupled to the rear spindle drive gear 220 via a first rear idler gear 222B. In some examples, rotation of the spindle drive gear 304 drives rotation of the first idler gears 222A, 222B about respective front and rear idler gear axes 224A, 224B. In turn, rotation of the first idler gears 222A, 222B drives rotation of the front and rear spindle drive gears 216, 220 about the respective front and rear drum axes 206A, 206B and, as a result, controls rotation of the respective front and rear spindles 204A, 204B about the respective spindle axes.

In the illustrated example of FIG. 2, the drum drive gear 302 of the gearbox 200 is operatively coupled to the front drum drive gear 214 via a second front idler gear 226A, and is operatively coupled to the rear drum drive gear 218 via a second rear idler gear 226B. In some examples, rotation of the drum drive gear 302 drives rotation of the second idler gears 226A, 226B about the respective front and rear idler gear axes 224A, 224B. In turn, rotation of the second idler gears 226A, 226B drives rotation of the front and rear drum drive gears 214, 218 about the respective front and rear drum axes 206A, 206B and, as a result, controls rotation of the respective front and rear drums 202A, 202B about the respective front and rear drum axes 206A, 206B. In this example, rotation of the first idler gears 222A, 222B is decoupled from rotation of the second idler gears 226A, 226B (e.g., the first idler gears 222A, 222B can rotate independently of the second idler gears 226A, 226B). As a result, the gearbox 200 can control the drum rotational speeds and the spindle rotational speeds independently (e.g., can increase or decrease the spindle rotational speed relative to the drum rotational speed, and/or can increase or decrease the drum rotational speed relative to the spindle rotational speed).

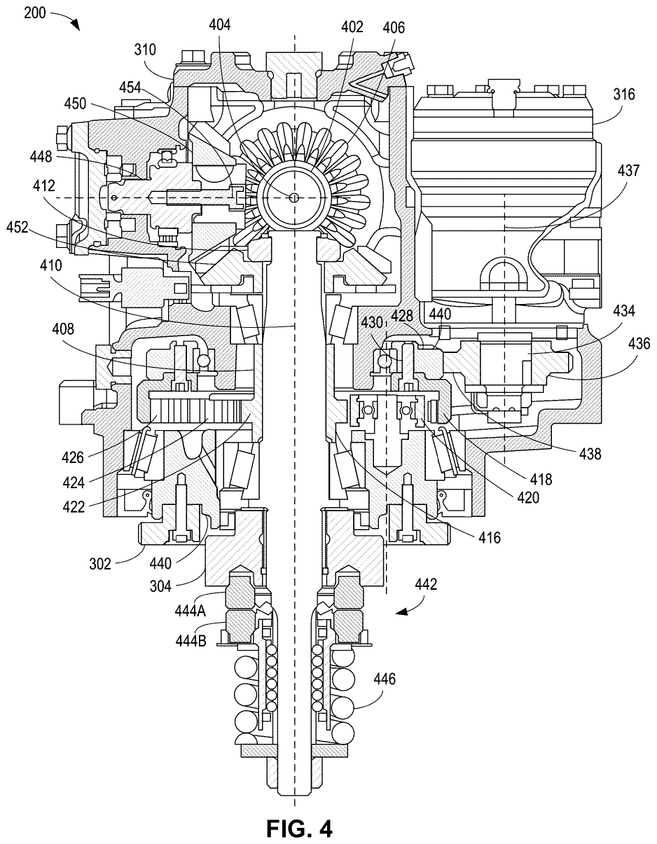

FIG. 4 is a cross-sectional view of the gearbox 200 taken along line A-A of FIG. 3. In the illustrated example of FIG. 4, the gearbox 200 includes an example input shaft (e.g., an input drive shaft) 402 positioned in the opening 312 of the housing 310 of FIG. 3, and the input shaft 402 defines a first example rotational axis 404 (e.g., extending into and/or out of the page in FIG. 4). In some examples, the first motor 314 of FIG. 3 can be operatively coupled to the input shaft 402 to drive rotation of the input shaft 402 about the first rotational axis 404. In this example, a first bevel gear 406 is coupled to and extends circumferentially around the input shaft 402. In some examples, the first bevel gear 406 is fixed relative to the input shaft 402, such that the first bevel gear 406 rotates with the input shaft 402 about the first rotational axis 404.

In the example of FIG. 4, the gearbox 200 includes a second shaft (e.g., a main drive shaft) 408 defining a second rotational axis 410, where the second rotational axis 410 is substantially perpendicular to the first rotational axis 404 (e.g., the second shaft 408 is substantially perpendicular to the input shaft 402). A second bevel gear 412 is coupled to and extends circumferentially around the second shaft 408. In some examples, the second bevel gear 412 is fixed relative to the second shaft 408, such that the second bevel gear 412 rotates with the second shaft 408 about the second rotational axis 410. In this example, the second bevel gear 412 engages with the first bevel gear 406, such that rotation of the input shaft 402 and, thus, the first bevel gear 406 about the first rotational axis 404 drives rotation of the second bevel gear 412 and, thus, the second shaft 408 about the second rotational axis 410. Further, the spindle drive gear 304 is coupled (e.g., fixedly coupled) to and extends circumferentially around the second shaft 408, such that the spindle drive gear 304 rotates with the second shaft 408 about the second rotational axis 410. Accordingly, rotation of the second shaft 408 drives rotation of the spindle drive gear 304 at a first rotational speed about the second rotational axis 410 and, thus, controls rotation of one or more spindles (e.g., the spindles 204 of FIG. 2) based on the first rotational speed.

In some examples, the input shaft 402 extends to one or more additional gearboxes (e.g., similar to the gearbox 200 of FIG. 4) associated with respective one(s) of the row units 116 of FIGS. 1A and 1B. In such examples, rotation of the input shaft 402 (e.g., by the first motor 314 of FIG. 3) can simultaneously control the rotation of the spindles 204 (e.g., at substantially the same rotational speeds) across multiple ones of the row units 116.

In the illustrated example of FIG. 4, an example planetary gear system 414 is operatively coupled to and extends circumferentially around a portion of the second shaft 408 (e.g., between the second bevel gear 412 and the spindle drive gear 304). In this example, the planetary gear system 414 includes a sun gear 416 coupled (e.g., fixedly coupled) to and extending circumferentially around the second shaft 408, a ring gear 418 spaced apart from and extending circumferentially around the sun gear 416, and one or more planet gears 420 coupled and/or positioned between the sun gear 416 and the ring gear 418. In this example, the sun gear 416, the ring gear 418, and the planet gears 420 lie (e.g., are oriented) along substantially the same plane (e.g., orthogonal to the second rotational axis 410). The sun gear 416 is fixed relative to the second shaft 408, such that the sun gear 416 rotates with the second shaft 408 about the second rotational axis 410 at the first rotational speed. In some examples, the sun gear 416 includes first external teeth 422 to engage second external teeth 424 of the planet gears 420, and the second external teeth 424 further engage internal teeth 426 of the ring gear 418. In this example, the first external teeth 422 are positioned on an outer circumference of the sun gear 416, the second external teeth 424 are positioned on outer circumferences of the planet gears 420, and the internal teeth 426 are positioned on an inner circumference of the ring gear 418.

In the illustrated example of FIG. 4, an example input ring gear 428 extends circumferentially around the second shaft 408 and is fixedly coupled (e.g., fastened) to the ring gear 418 (e.g., via one or more fasteners 430), such that the input ring gear 428 and the ring gear 418 rotate together about the second rotational axis 410. While the input ring gear 428 and the ring gear 418 are fastened together in this example, the input gear 428 and the ring gear 418 can be welded in some examples. In some examples, the input ring gear 428 is integral to the ring gear 418 (e.g., the input ring gear 428 and the ring gear 418 are formed as a single (e.g., unitary, continuous) part).

In this example, the second motor 316 operatively coupled to the ring gear 418 to drive rotation of the ring gear 418 about the second rotational axis 410. For example, the second motor 316 includes an output shaft 434 extending into the housing 310, where operation of the second motor 316 drives rotation of the output shaft 434 about a third rotational axis 437 (e.g., a longitudinal axis of the output shaft 434). An output gear 436 is coupled (e.g., fixedly coupled) to and extends circumferentially around the output shaft 434, such that the output gear 436 rotates with the output shaft 434 about the third rotational axis 437. The output gear 436 includes third external teeth 438, and the third external teeth 438 engage (e.g., mesh) with fourth external teeth 439 of the input ring gear 428 (e.g., where the fourth external teeth 439 are positioned on an outer circumference of the input ring gear 428). As a result, rotation of the output gear 436 about the third rotational axis 437 drives rotation of the input ring gear 428 and, thus, the ring gear 418 about the second rotational axis 410 at a second rotational speed. In some examples, the first sensor 306 of FIG. 3 is to detect the first rotational speed of the second shaft 408 and/or the sun gear 416, and the second sensor 308 of FIG. 3 is to detect the second rotational speed of the ring gear 418 and/or the input ring gear 428.

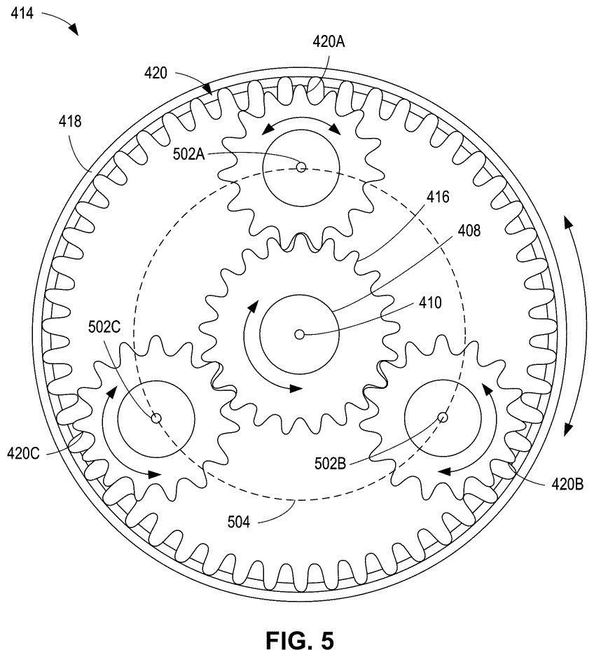

In the illustrated example of FIG. 4, an example carrier 440 is coupled to the planet gears 420. In some examples, relative rotation between the sun gear 416 and the ring gear 418 drives rotation and/or translation of the one or more planet gears 420 and, thus, the carrier 440 about the second rotational axis 410. For example, FIG. 5 is a top down view of the planetary gear system 414 of FIG. 4. In the illustrated example of FIG. 5, the planetary gear system 414 includes three of the planet gears 420 (e.g., a first planet gear 420A, a second planet gear 420B, and a third planet gear 420C) operatively coupled between the sun gear 416 and the ring gear 418 and spaced circumferentially about the second shaft 408. In some examples, a different number of the planet gears 420 (e.g., two, four or more) may be used instead.

In some examples, the sun gear 416 and the ring gear 418 are rotatable about the second rotational axis 410 (e.g., in a clockwise direction and a counterclockwise direction of FIG. 5). When the sun gear 416 and/or the ring gear 418 rotate about the second rotational axis 410, relative rotation between the sun gear 416 and the ring gear 418 drives rotation of the first, second, and third planet gears 420A, 420B, 420C about respective first, second, and third gear axes 502A, 502B, 502C (collectively referred to herein as gear axes 502). Further, rotation of the planet gears 420 about the respective gear axes 502 results in travel of the planet gears 420 along a circular path 504 extending circumferentially around the second rotational axis 410. As a result, the planet gears 420 can rotate about the second rotational axis 410 at a third rotational speed, where the third rotational speed is based on a difference between the first rotational speed of the sun gear 416 and the second rotational speed of the ring gear 418.

Returning to FIG. 4, the drum drive gear 302 is coupled (e.g., fixedly coupled, fastened) to the carrier 440. In this example, the drum drive gear 302 is fixedly coupled to the carrier 440 (e.g., via one or more fasteners, via a welded connection, etc.). In some examples, the drum drive gear 302 can be welded to the carrier 440, integrally formed with the carrier 440, etc. Because the drum drive gear 302 and the carrier 440 are fixedly coupled, the drum drive gear 302 rotates with the carrier 440 about the second rotational axis 410 at the third rotational speed. In some examples, the drum drive gear 302 is operatively coupled to one or more drums (e.g., the drums 202 of FIG. 2) of a corresponding one of the row units 116 of FIGS. 1A and 1B. In such examples, rotation of the drum drive gear 302 at the third rotational speed controls a rotational speed of the drum(s) 202 of the row unit 116.

In operation, the first motor 314 of FIG. 3 drives rotation of the spindle drive gear 304 (e.g., via the input shaft 402, the first bevel gear 406, the second bevel gear 412, and the second shaft 408) about the second rotational axis 410 at a first rotational speed. Further, the first motor 314 drives rotation of the sun gear 416 (e.g., via the input shaft 402, the first bevel gear 406, the second bevel gear 412, and the second shaft 408) about the second rotational axis 410 at the first rotational speed, the second motor 316 drives rotation of the ring gear 418 (e.g., via the output shaft 434, the output gear 436, and the input ring gear 428) about the second rotational axis 410 at a second rotational speed, and relative rotation between the sun gear 416 and the ring gear 418 drives rotation of the planet gears 420, the carrier 440, and, thus, the drum drive gear 302 about the second rotational axis 410 at a third rotational speed. Stated differently, the spindle drive gear 304 is driven based on a first input from the first motor 314, and the drum drive gear 302 is driven based on the first input from the first motor 314 and a second input from the second motor 316. As a result, the rotational speed and/or direction of the spindle drive gear 304 (and, thus, the spindles of the corresponding row unit 116) can be controlled by adjusting the rotational speed and/or direction of the first motor 314. Further, because the rotational speed and direction of the drum drive gear 302 is based on the relative rotation between the sun gear 416 (e.g., driven by the first motor 314) and the ring gear 418 (e.g., driven by the second motor), the rotational speed and/or direction of the drum drive gear 302 can be controlled by adjusting the rotational speed and/or direction of one or both of the first motor 314 and the second motor 316.

In some examples, the drum drive gear 302 can be driven within a range of operational speeds by adjusting the rotational speed and/or direction of the first motor 314 while adjusting only the rotational speed of the second motor 316 in one direction (e.g., clockwise or counterclockwise about the third rotational axis 437). For example, instead of reversing a rotational direction of the second motor 316 (and, thus, the ring gear 418), the rotational speed of the second motor 316 can be slowed and/or reduced relative to the rotational speed of the first motor 314 to vary the relative rotation between the sun gear 416 and the ring gear 418 and, as a result, vary the rotational speed and/or direction of the drum drive gear 302. In some examples, when the second motor 316 is a hydraulic motor, a hydraulic system of the cotton harvester 100 of FIGS. 1A and 1B is operatively and/or fluidly coupled to the second motor 316 to drive rotation of the second motor 316 in one direction. In such examples, because operation of the drum drive gear 302 does not necessitate rotation of the second motor 316 in two directions, a complexity and/or a number of parts associated with the hydraulic system can be reduced (e.g., compared to when the hydraulic system is to drive the second motor 316 in two directions).

In some examples, ratios between the rotational speeds of the first motor 314, the second motor 316, the drum drive gear 302, and the spindle drive gear 304 are based on gear ratios between corresponding gears (e.g., the first bevel gear 406, the second bevel gear 412, the sun gear 416, the ring gear 418, the planet gears 420, the output gear 436, the input ring gear 428, etc.) of the gearbox 200. For example, the gear ratios are based on numbers of teeth of the corresponding gears. In the illustrated example of FIG. 4, the first bevel gear 406 includes 21 teeth, the second bevel gear 412 includes 29 teeth, the sun gear 416 includes 22 teeth, the ring gear 418 includes 62 teeth, the planet gears 420 include 20 teeth, the output gear 436 includes 29 teeth, and the input ring gear 428 includes 66 teeth. In some examples, a number of teeth of one or more of the gears (e.g., the first bevel gear 406, the second bevel gear 412, the sun gear 416, the ring gear 418, the planet gears 420, the output gear 436, and/or the input ring gear 428) may be different.

In some examples, a rotational speed of the spindles 204 of the corresponding row unit 116 is based on the first rotational speed of the spindle drive gear 304 and a number of teeth of the spindle drive gear 304, and a rotational speed of the drum(s) 202 of the corresponding row unit 116 is based on the third rotational speed of the of the drum drive gear 302 and a number of teeth of the drum drive gear 302. In the illustrated example of FIG. 4, the spindle drive gear 304 includes 21 teeth and the drum drive gear 302 includes 40 teeth. In some examples, a number of teeth of the spindle drive gear 304 and/or the drum drive gear 302 may be different.

In the illustrated example of FIG. 4, the gearbox 200 includes an example slip clutch 442 including first and second jaws 444A, 444B, and a spring 446 to bias the second jaw 444B toward the first jaw 444A. In some examples, the slip clutch 442 can mechanically decouple the gearbox 200 from one or more components of the corresponding row unit 116 during a torque overload condition (e.g., when a torque applied by the motor(s) 314, 316 exceeds a threshold). For example, a torque overload condition may occur as a result of an obstruction in the row unit 116, etc. In some examples, the slip clutch 442 can prevent and/or reduce damage to and/or wear of one or more components of the gearbox 200 and/or the row unit 116 by restricting the torque applied to the one or more components.

In some examples, oil and/or other lubricant(s) may be provided to and/or contained within the housing 310 to lubricate one or more gears (e.g., the first bevel gear 406, the second bevel gear 412, the sun gear 416, the ring gear 418, the planet gears 420, the output gear 436, the input ring gear 428, the spindle drive gear 304, the drum drive gear 302, etc.) of the gearbox 200. In some examples, some of the oil may settle and/or reside in one or more areas of the housing 310, resulting in a rise in temperature of the oil during operation of the cotton harvester 100. In some examples, elevated oil temperatures (e.g., oil temperatures at or above a threshold temperature) may result in wear of the gears and, thus, may reduce operating efficiency of the gearbox 200.

In the illustrated example of FIG. 4, the gearbox 200 includes an example gerotor (e.g., a gerotor pump, a positive displacement pump) 448 operatively coupled to the input shaft 402 via a third bevel gear 450 and a fourth bevel gear 452. In this example, the third bevel gear 450 is coupled to and rotatable with the gerotor 448, and the fourth bevel gear 452 is coupled to and rotatable with the second shaft 408. In some examples, operation of the first input shaft 402 and, thus, the second shaft 408 and the fourth bevel gear 452 drives operation of the third bevel gear 450 and, thus, the gerotor 448 about a fourth example rotational axis 454. In some examples, rotation of the gerotor 448 about the fourth rotational axis 454 drives circulation of the oil within the housing 310. Such circulation can reduce a temperature of the oil in the housing 310, which can improve operating efficiency of the gearbox 200.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real-world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time +1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

From the foregoing, it will be appreciated that example systems, apparatus, articles of manufacture, and methods have been described that enable independent control of a drum and spindles of a row unit of a cotton harvester. Described examples utilize an example gearbox to drive rotation of the spindles based on a first input from a first motor, and drive rotation of the drum based on the first input from the first motor and a second input from a second motor. For example, the first motor drives, via a driveshaft of the gearbox, rotation of a spindle drive gear extending circumferentially around the driveshaft. Further, a drum drive gear is operatively coupled to the first and second motors via a planetary gear system extending circumferentially around the driveshaft. In such examples, the first and second motors drive rotation of the drum drive gear by controlling relative rotation between gears of the planetary gear system. By enabling independent control of the drum drive gear and the spindle drive gear, examples described herein can drive the drum and spindles at speeds independent of a ground speed of the cotton harvester and, thus, can improve efficiency of a cotton harvesting operation.

Further, examples described herein utilize gears to transmit power from the motors to the drive gears, which can reduce power loss and/or improve reliability compared to other transmission systems (e.g., belt-and-pulley systems). Additionally, examples described herein enable the drum drive gear to be driven at a range of operational speeds without reversing a rotational direction of the second motor which can, in turn, enable a reduction in complexity of a hydraulic system operatively coupled to the second motor. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus to control a drum and spindles of a row unit of a cotton harvester, the apparatus comprising:
a shaft operatively coupled to a first motor, the shaft defining a rotational axis, the first motor to drive rotation of the shaft about the rotational axis at a first rotational speed;
a spindle drive gear coupled to and extending circumferentially around the shaft, the spindle drive gear to rotate with the shaft about the rotational axis at the first rotational speed, the rotation of the spindle drive gear to control rotation of the spindles; and
a drum drive gear operatively coupled to the shaft via a planetary gear system, the drum drive gear and the planetary gear system extending circumferentially around the shaft, a second motor and the shaft to drive, via the planetary gear system, rotation of the drum drive gear about the rotational axis at a second rotational speed, the second rotational speed based on the first rotational speed, the rotation of the drum drive gear to control rotation of the drum.

2. The apparatus of claim 1, wherein the planetary gear system includes:
a sun gear coupled to and extending circumferentially around the shaft, the sun gear to rotate with the shaft about the rotational axis at the first rotational speed;
a ring gear extending circumferentially around the sun gear, the second motor to drive rotation of the ring gear about the rotational axis at a third rotational speed;
a planet gear operatively coupled between the sun gear and the ring gear; and
a carrier operatively coupled between the planet gear and the drum drive gear, the carrier to rotate about the rotational axis at the second rotational speed, the second rotational speed based on a ratio between the first rotational speed and the third rotational speed.

3. The apparatus of claim 2, further including a first sensor and a second sensor coupled to a housing of the row unit, the first sensor configured to detect the first rotational speed of the shaft, the second sensor configured to detect the third rotational speed of the ring gear.

4. The apparatus of claim 2, wherein the sun gear includes 22 teeth, the planet gear includes 20 teeth, and the ring gear includes 62 teeth.

5. The apparatus of claim 2, further including an input ring gear fixedly coupled to and rotatable with the ring gear, the ring gear including internal teeth positioned on an inner circumference of the ring gear, the input ring gear including external teeth positioned on an outer circumference of the input ring gear.

6. The apparatus of claim 5, wherein the external teeth are first external teeth, the first external teeth to engage second external teeth of an output gear coupled to an output shaft of the second motor.

7. The apparatus of claim 1, wherein the first motor is rotatable in two directions, and the second motor is rotatable in one direction.

8. The apparatus of claim 1, further including a positive displacement pump operatively coupled to the shaft, rotation of the shaft to drive operation of the positive displacement pump, the operation of the positive displacement pump to drive circulation of oil in a housing of the row unit.

9. The apparatus of claim 1, wherein at least one of the first motor or the second motor includes a hydraulic motor.

10. The apparatus of claim 1, wherein the shaft is a first shaft including a first bevel gear, further including a second shaft operatively coupled to and substantially perpendicular to the first shaft, the second shaft including a second bevel gear to engage the first bevel gear, the first motor to drive rotation of the second shaft, the second shaft to drive rotation of the first shaft via the first and second bevel gears.

11. The apparatus of claim 10, wherein the row unit is a first row unit, the spindles are first spindles, the second shaft to extend to a second row unit of the cotton harvester, rotation of the second shaft to drive rotation of the first spindles of the first row unit and second spindles of the second row unit at substantially the same speed.

12. An apparatus comprising:
a first drive gear to be operatively coupled to spindles of a row unit of a cotton harvester;
a second drive gear to be operatively coupled to a drum of the row unit; and
a drive shaft to be fixedly coupled to the first drive gear and to be operatively coupled, via a planetary gear system, to the second drive gear, the first and second drive gears and the planetary gear system to extend circumferentially around the drive shaft, the first drive gear to rotate with the drive shaft about a longitudinal axis of the drive shaft, the second drive gear rotatable relative to the first drive gear about the longitudinal axis.

13. The apparatus of claim 12, wherein the planetary gear system includes:
a sun gear fixedly coupled to and rotatable with the drive shaft;
a ring gear spaced about from and extending circumferentially around the drive shaft;
a planet gear coupled between the sun gear and the ring gear, the planet gear to travel around the drive shaft based on relative rotation between the sun gear and the ring gear; and
a carrier coupled between the second drive gear and the planet gear.

14. The apparatus of claim 13, wherein the sun gear, the ring gear, and the planet gear are oriented along substantially the same plane.

15. The apparatus of claim 13, further including:
a first motor operatively coupled to the drive shaft to drive rotation of the drive shaft, the first drive gear, and the sun gear about the longitudinal axis at a first rotational speed; and
a second motor operatively coupled to the ring gear to drive rotation of the ring gear about the longitudinal axis at a second rotational speed, the second drive gear to rotate about the longitudinal axis at a third rotational speed based on the first rotational speed and the second rotational speed.

16. The apparatus of claim 15, wherein at least one of the first motor or the second motor includes a hydraulic motor.

17. The apparatus of claim 15, wherein the first motor is rotatable in a first direction and a second direction, the second motor rotatable in one of the first direction or the second direction.

18. The apparatus of claim 15, wherein the first motor is operatively coupled to the drive shaft via an input shaft, the input shaft substantially perpendicular to the drive shaft.

19. The apparatus of claim 18, wherein the row unit is a first row unit, the spindles are first spindles, the input shaft to extend to a second row unit of the cotton harvester, rotation of the input shaft to drive rotation of the first spindles of the first row unit and second spindles of the second row unit at substantially the same speed.

20. The apparatus of claim 12, further including a pump operatively coupled to the drive shaft, rotation of the drive shaft to drive operation of the pump to drive circulation of lubricant in a housing of the row unit.
